(19) United States
(12) Patent Application Publication
(10) Pub. No.: US 2017/0372223 A1
(43) Pub. Date: Dec. 28, 2017

(54) SMART CROWD-SOURCED AUTOMATIC INDOOR DISCOVERY AND MAPPING

(71) Applicant: INTEL CORPORATION, SANTA CLARA, CA (US)

(72) Inventors: ROBERT L. VAUGHN, PORTLAND, OR (US); JENNIFER N. JOHNSON, WEST SACRAMENTO, CA (US)

(21) Appl. No.: 15/192,509

(22) Filed: Jun. 24, 2016

(51) Int. Cl. G06N 99/00; G06F 17/30; G06F 17/50

(52) U.S. Cl. CPC G06N 99/005; G06F 17/5004; G06F 17/30061; G06F 17/30867

(57) ABSTRACT

A mechanism is described for facilitating smart crowd-sourced automatic indoor discovery and mapping according to one embodiment. A method of embodiments, as described herein, includes collecting data relating to a facility, where the data is based on one or more of movement data, contextual data, and observation data relating to at least one of an indoor space and one or more users of the indoor space. The method may further include generating one or more dynamic profiles of the indoor space and the occupants, and building a map of the indoor space based on the one or more dynamic profiles.

### FIELD

Embodiments described herein generally relate to computers. More particularly, embodiments relate to facilitating smart crowd-sourced automatic indoor discovery and mapping.

### BACKGROUND

Conventional crowd-sourced mapping solutions are manual and thus such solutions are severely limited in that they severely lack the ability to identify names of location, unless the locations have been explicitly defined through social tagging or manual entries. Accordingly, conventional solutions are manual, labor-intensive, and prone to human errors.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a smart mapping mechanism according to one embodiment.

FIG. 2 illustrates a smart mapping mechanism according to one embodiment.

FIG. 3A illustrates a use-case scenario according to one embodiment.

FIG. 3B illustrates a use-case scenario according to one embodiment.

FIG. 3C illustrates a table according to one embodiment.

FIG. 4A illustrates a method for facilitating smart crowd-sourced mapping according to one embodiment.

FIG. 4B illustrates a method for facilitating smart crowd-sourced mapping according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel crowd-soured mapping technique facilitating automatic discovery (such as without any prior knowledge or explicit naming) of specific locations, where these specific locations may be indoor facility locations, such as conference room locations, cafeteria or break room locations, bathroom locations, office locations, etc., of specified users. For example, this novel technique may be freely applied in enterprise environments with zero to minimal setup by any relevant operators or users, while automatically and dynamically learning and adapting to changes in floor layouts, remodels, new constructions, wireless infrastructures, etc.

Embodiments provide for collection of data and analysis of the collected data to seek better insight into allocation of a specific building room, a factory machine, etc., and its purposes. Further, a learning engine may be used to filter out any errors from the analyzed collected data and continuously learn and change to a given environment, while seeking common-most used pathways for directional guidance. Moreover, instant directional guidance technique may be used to guide a user from, for example, one point in the building to another point with information and suggestions relating to time of arrival, best route, etc.

Conventional indoor mapping techniques require manual drawings and lack the ability to automatically discover indoor data. Similarly, conventional outdoor mapping techniques depend on various instruments, such as Global Positioning System (GPS), whose granularity is not suited for indoor accuracy, while still requiring manual intensive map building process that necessitates a great deal of time for building accurate maps.

It is contemplated and to be noted that embodiments are not limited to any particular number and type of powered devices, unpowered objects, software applications, application services, customized settings, etc., or any particular number and type of computing devices, networks, deployment details, etc.; however, for the sake of brevity, clarity, and ease of understanding, throughout this document, references are made to various sensors, cameras, microphones, speakers, display screens, user interfaces, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

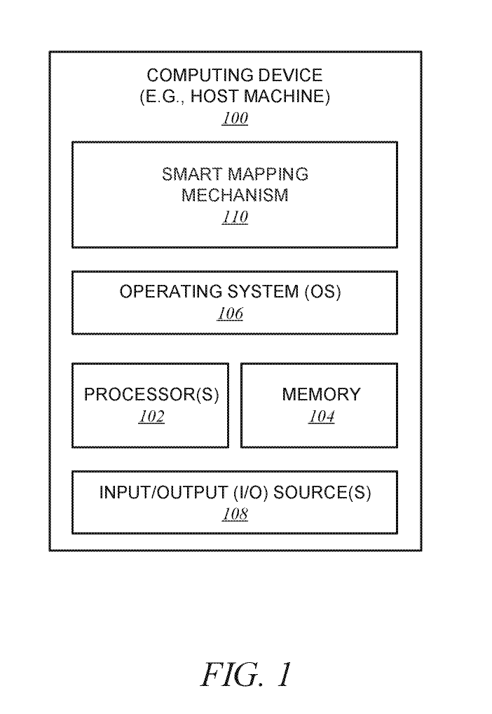

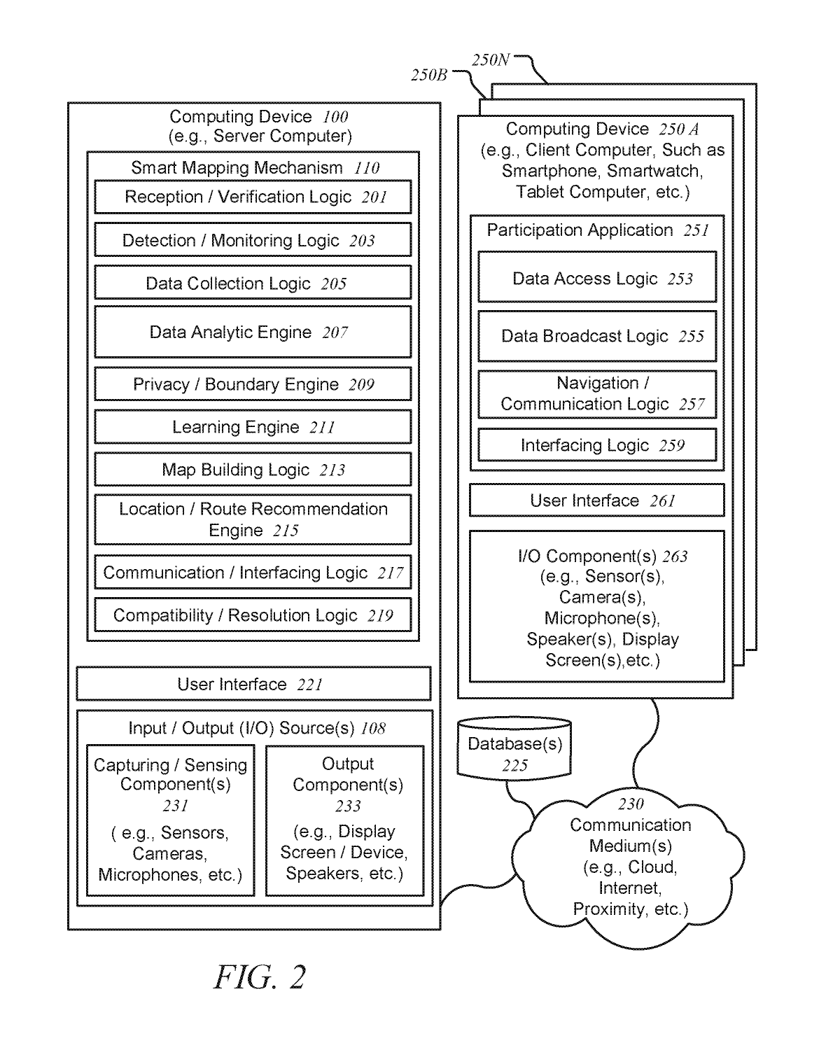

FIG. 1 illustrates a computing device 100 employing a smart mapping mechanism (“mapping mechanism”) 110 according to one embodiment. Computing device 100 (e.g., server computing device, such as cloud-based server computer) serves as a host machine for mapping mechanism 110 that includes any number and type of components, as illustrated in FIG. 2, to facilitate one or more dynamic and automatic mapping measures, such as collecting data, analyzing data, plotting data, offering instant directions, etc., as will be further described throughout this document.

Computing device 100 may include any number and type of data processing devices/technologies or be in communication with other data processing devices, such as computing devices 250A-N (e.g., mobile or portable computers, such as smartphones, tablets, laptops, etc.) of FIG. 2. It is contemplated that computing device 100 and computing devices 250A-N of FIG. 2 are not limited in anyway and may further include any number and type of computing devices, such as set-top boxes (e.g., Internet-based cable television set-top boxes, etc.), global positioning system (GPS)-based devices, etc. Further, for example, computing device 100 may include any number and type of mobile computing devices and/or be in communication with other mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, HMDs (e.g., wearable glasses, head-mounted binoculars, gaming displays, military headwear, etc.), and other wearable devices (e.g., smartwatches, bracelets, smartcards, jewelry, clothing items, etc.), Internet of Things (IoT) devices, and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates mapping mechanism 110 of FIG. 1 according to one embodiment. In one embodiment, mapping mechanism 110 may include any number and type of components, such as (without limitation): reception/verification logic 201; detection/monitoring logic 203; data collection logic 205; data analytic engine 207; privacy/boundary engine (“privacy engine”) 209; learning engine 211; map building logic 213; location/route recommendation engine (“recommendation engine”) 215; communication/interfacing logic 217; and compatibility/resolution logic 219.

Computing device 100 is further shown to include user interface 221 (e.g., graphical user interface (GUI)-based user interface, Web browser, cloud-based platform user interface, software application-based user interface, other user or application programming interfaces (APIs) etc.), as facilitated by communication/interfacing logic 217. Computing device 100 further includes I/O source(s) 108 having capturing/sensing component(s) 231 and output component(s) 233.

Computing device 100 is further illustrated as having access to and/or being in communication with one or more database(s) 225 and/or one or more of other computing devices over one or more communication medium(s) 230 (e.g., networks, such as a cloud network, a proximity network, the Internet, etc.). Further, in one embodiment, mapping mechanism 110 may be hosted entirely at and by computing device 100. In another embodiment, one or more components of mapping mechanism 110 may be hosted at and by another computing device, such as computing devices 250A-N.

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O source(s) 108 including capturing/sensing component(s) 231 and/or output component(s) 233. For example, capturing/sensing components 231 may include sensor array (such as microphones or microphone array (e.g., ultrasound microphones), cameras or camera array (e.g., two-dimensional (2D) cameras, three-dimensional (3D) cameras, infrared (IR) cameras, depth-sensing cameras, etc.), capacitors, radio components, radar components, etc.), scanners, accelerometers, etc. Similarly, output component(s) 233 may include any number and type of display devices or screens, projectors, speakers, light-emitting diodes (LEDs), one or more speakers and/or vibration motors, etc.

In one embodiment, each of computing devices 250A-N may host a participating software application (“participation application”), such as participation application 251 at computing device 250A, for participating in making and navigating of maps in communication with mapping mechanism 110 at computing device 100 over one or more communication medium(s) 230, such a cloud network, the Internet, etc. In one embodiment, participation application 251 may include any number and type of components, such as (without limitations): data access logic 253; data broadcast logic 255; navigation/communication logic 257; and interfacing logic 259. Computing device 250A is further shown to include user interface 261 (e.g., GUI interface, Web browser, etc.), such as a specific application-based interface (e.g., participation application-based interface) or any other generic interface, such as a Web browser, where user interface 261 may be facilitated by interfacing logic 259 and/or communication/interfacing logic 217. Further, like I/O source(s) 108 of computing device 100, it is contemplated that computing devices 250A-N may also host I/O components, such as I/O components 263 (e.g., microphones, speakers, cameras, sensors, display screens, etc.) of computing device 250A.

Referring back to mapping mechanism 110, reception/verification logic 201 may be used to receive any information or data, such as request for participation, from one or more of computing devices 250A-N, where reception/verification logic 201 may be further to verify or authenticate computing devices 250A-N before and/or during their participation in various mapping tasks, as described throughout this document. Further, in one embodiment, detection/monitoring logic 203 may be used to detect and monitor computing devices 250A-N using one or more detection/identification techniques (such as cell tower registration, GPS ping, media access control (MAC) probe requests, etc.) to keep track and stay aware of exact physical locations and/or paths of participating computing devices 250A-N.

It is contemplated that users, such as users A, B, N, of computing devices 250A, 250B, 250N, respectively, may choose to opt-in to seek benefits of smart mapping mechanism 110 by downloading participation application 251 on their respectively computing devices 250A-N and registering with computing device 100 through user interface 261, such as by filling and sending out a consent or participation form offered through participation application 251.

Referring back to computing device 100, detection/monitoring logic 203 may actively probe or track computing devices 250A-N over communication medium(s) 230, while, in another embodiment, passive tracking or monitoring may be performed by detection/monitoring logic 203 based on location/path data received from computing devices 250A-N, as aggregated by data collection logic 205 and broadcasted by data broadcast logic 255 over communication medium(s) 230.

Embodiments provide for data collection, location tracking, application data, behavioral data, etc., as facilitated by various components 201-219 of mapping mechanism 110, where this collected and analyzed data may be used to extract specific indoor locations of a facility (e.g., building, campus, etc.), such as meeting rooms, common areas, office locations, etc. For example, in one embodiment, data collection logic 205 may be used to continuously (e.g., non-stop) or periodically (e.g., upon reaching regular time intervals or specified events) or on-demand (e.g., when triggered or requested by users, events, etc.) poll computing devices 250A-N to track and determine their physical locations relative to corresponding routers or cell towers around them, such as at or within certain proximity of the facility, so as to track their physical locations and/or the time at which they were detected at those physical locations.

As will be further described in this document, for example, data access logic 253 may be used to provide a unique perspective into a location (e.g., a conference room in an office building) of computing device 250A by accessing relevant applications (e.g., calendar application, meeting application, email application, etc.) and/or local data storage associated with or accessible by computing device 250A to extract the relevant data denoting the location. For example, data access logic 253 may access user A′s calendar application at computing device 250A to extract information revealing that user A of computing device 250A is scheduled to attend a meeting in conference room A at 2 PM and similarly, other information (e.g., user contact information, such as mail stop, pole number, etc.) may be gathered by data access logic 253 to then provide to data broadcast logic 255 to then communicate with data collection logic 205 over one or more communication medium(s) 230. This data may then be analyzed by data analytic engine 207 to, for example, conclude that at 2 PM, the exact indoor physical location of computing device 250A is conference room A.

In one embodiment, additional information, such as the entire path or route taken by user A from their office to conference room A by tracking computing device 250A along with any detours taken by user A, such as visiting a bathroom or their supervisor's office, either directly by detection/monitoring logic 203 or through data communication between data access logic 253, data broadcast logic 255, and/or data collection logic 205. Further, for example, data analytic engine 207 may be used to analyze the collected data, such as behavioral data, how long a user was at a particular location (such as how long in conference room A), where did the user go before or after or instead of the location (e.g., bathroom, supervisor's office), where did the user spent most of their time, and/or the like.

In one embodiment, data analytic engine 207 may be used to analyze the collection data to determine or verify the exact location, such as whether conference room A is in fact conference room A and that it is not mistaken for conference room A, and similarly, data analytic engine 207 may be further used to analyze characteristics relating to the route taken by the user, such as whether the route is the shortest route, fastest route, recommended route based on any number of factors, such as (without limitations) company policies, local environment (e.g., construction or renovation), legal sensitivities, technical limits, cultural values (e.g., cultural segregation of genders), etc. For example, certain sections of the building may be off limits to lower grade employees, students may not allowed to pass through certain areas dedicated for teachers in a campus building, lawyers and/or engineers be allowed to a particular wing of a facility for legal and/or technical reasons, and/or the like.

Further, for example, data analytic engine 207 may also be used to analyze other relevant data associated with other users, such as users B and N having access to computing devices 250B and 250N, respectively, to determine whether they were also invited to the same meeting being held in conference room A at 2 M as user A associated with computing device 250A and if they were invited and subsequently attend the meeting, then data analytic engine 207 may use this additional information relating to computing devices 250B, 250N to further confirm computing device A 250A being in conference room A.

Although data analytic engine 207 is fully capable of analyzing any amount and type of data being broadcast by data broadcast logic 255 and collected by data collection logic 205, in one embodiment, privacy engine 209 is used to ensure data is not over-collected or harvested for unintended purposes. For example, privacy engine 209 provide a check over all the data collected by data collection logic 205 so that privacy and security of individuals, facilities, etc., are safeguarded, such as for users associated with computing devices 250A-N and other relevant persons, etc., while fully complying with any governmental laws, public policies, company rules, and other applicable regulations.

For example, to confirm that personal privacy of individuals (such as when user A in the bathroom) is not violated, privacy engine 209 provides for a novel technique of keeping and maintaining anonymity of crowd-sourced location identification relating to any facility. For example, rather than explicitly tracking computing device 250A from location A to location B and everywhere in between, merely the origin and the destination of computing device 250A may be regarded as sufficient and analyzed by data analytic engine 207; particularly, for example, when the destination is capable of being known (such as known to be a bathroom) from or as described in another application or system (e.g., email application (e.g., Outlook® by Microsoft®, a ticket dispatch system, etc.).

Further, for example, data analytic engine 207 may analyze how users A-N and their corresponding computing devices 250A-N move through a building, such as what route they take, etc.; however, it may not be necessary to disclose the actual names of any of users A-N. In one embodiment, privacy engine 209 capable of keeping anonymous the “token” that identifies a user, such as user A, from their computing device, such as computing device 250A (e.g., smartphone, smart watch, radio frequency identification (RFID) tag, etc.).

In one embodiment, upon opting in, users A-N of computing devices 250A-N may be offered an option of listing their preferences through user interface 261, where the preferences may be maintained as user profiles to identify what users A-N may or may not like or prefer, such as a user may choose to remain completely anonymous or partially anonymous (e.g., not share person information when in the bathroom, etc.) or prefer to be identified. A user profile may be taken into consideration by privacy engine 209 for filtering out sections of data relating to the user as set forth in the corresponding user profile prior to offering the data to learning engine 211 for any additional considerations or processing.

Referring back to device identification, for example, computing device 250A (e.g., smartphone) may be identified using any number and type of techniques, such as cell tower registration, GPS pings, MAC probe requests, etc. For example, even randomized MAC addresses may be easily tracked from within a network, such as communication network. However, a unique identifier may be broadcast, such as by broadcast logic 255 or another source (e.g., router, tower, etc.), and architected to work merely on registered networks or open during certain times then this identifying information may become purpose-built for location broadcasting. The client-side location broadcast identified may share a unique address, while at a known original and at the destination. In between the origin and destination, the unique identifier may be randomized to obfuscate the users' routes.

In some embodiments, learning engine 211 may be triggered to provide the necessary intelligence to take into consideration other forms of data collection, such as arm motions of the users may be accessed from database(s) 225 or observed using one or more cameras and/or one or more sensors, etc., of I/O components 263 of computing device 250A, which may then be used to identify what a location is being used for and, while implementing a privacy rule and boundary if the location (e.g., bathroom) and/or the act (e.g., using bathroom) of the user is identified as private. It is contemplated that privacy may be relaxed or tightened according to user profiles or as desired or necessitated, such as different laws in different countries may lead to varying privacy levels.

In brief, arm motions may refer to movements of various body part of the user's body that can suggest the user's acts or intentions (such as moving an arm when pouring coffee, washing hands, and/or the like) that are then capable of being interpreted by learning engine 211 to determine respective locations (such as pouring coffee suggest the user is in the kitchen, washing hands suggests the user is in the bathroom, and/or the like). In one embodiment, these various bodily movements may be collected, in real-time, by one or more sensors of I/O component(s) 263 of computing devices 250A-N, classified as arm motion database, and subsequently, stored at one or more databases, such as database(s) 225, or directly communicated over to data collection engine 205 of smart mapping mechanism 110. In one embodiment, this arm motion database at database(s) 225 may be accessed by data collection engine 205 and offered to learning engine 211 for smart interpretation, where this arm motion database may also be shared with data analytics engine 207 and/or privacy engine 209 for additional processing.

Referring back to the scenario previously discussed, for example, computing device 250A associated with user A may be tracked from cubicle 101 (of user A) to conference room A where user A is scheduled to attend a meeting. In this case, computing device 250A is tracked from the origin, being cubicle 101, to the destination, being conference room A, to conclude that user A has made it to the meeting at a specified time taking a particular path. In one embodiment, the entire route from cubicle 101 to conference room A may be tracked, while, in another embodiment, the route may not be tracked and the information may be kept limited to disclosing the origin and/or the destination.

Similarly, if users B and N associated with computing devices 250B and 250N are also scheduled to the same meeting at the same time in the same conference room, such as conference room A, then their corresponding computing devices 250B and 250N may be tracked using one or more sensors of I/O components at computing devices 250B, 250N to indicate that they have made it to conference room A, where learning engine 211 may use this additional information to reinforce and reconfirm the exact physical location and the name of conference room A (that was previously deciphered from the movements of user A and/or computing device 250A). In other words, this tracking and confirmation of one or more of computing devices 250A-N can be used to identify a location (such as “destination”, etc.) within a facility, its name (such as “conference room A”, etc.), any other relevant information (e.g., “between library and conference room B” or “in the east wing of the tenth floor of the building”, etc.), any recommended routes (such as the shortest path from cubicle 101 to conference room A, etc.), and/or the like.

In one embodiment, when tracking the path, such as the best route taken by user A, computing device 250A may randomize user A's location broadcast data, using broadcast logic 255, as user A walks from cubicle 101 to conference room A. This broadcast frequency and randomized data, as communicated from data broadcast logic 255 and/or navigation/communication logic 257 to data collection logic 205 and/or communication/interfacing logic 217 over communication medium(s) 230, are configurable to provide resolution control as facilitated by learning engine 211.

Further, in one embodiment, using the aforementioned data, learning engine 211 is capable of establishing an exact physical location, such as where a bathroom is in a building, without having to obtain or use any other knowledge relating to the person, such as the name of the person who might be using the bathroom. For example, for the sake of maintain preferred and/or required levels of privacy and/or secrecy, once a location (such as the bathroom) is identified, there may not remain any need to track any additional information (such as who might be within the boundaries of that identified location).

However, in another embodiment, it is contemplated that there might be occasions when additional data might be collected still without sacrificing or violating the basic privacy of the user and/or the facility. For example, in some embodiments, periodic monitoring of a private location (such as a bathroom, a secret laboratory, a legal filing room, etc.) may be performed (e.g., using one or more sensors of I/O components 263 of computing device 250A in cooperation with or in addition to other tracking mechanisms, such as GPS) for any number of reasons, such as to verify or confirm the location (such as whether the location is in fact a bathroom), any ongoing or anticipated changes to the location (such as remodeling, moving to another location, shutting down, etc.), and/or the like.

Once any behavioral data, application data, and/or location data relating to user A has been gathered from computing device 250A, this data may then be processed from a crowd-sourced view. For example, given that a user, such as user A, stayed at a location, such as conference room A, for a period of time, such as 5 minutes, then how many other users, such as users B and N, did the same thing, such as stayed at conference room A for 5 minutes. In one embodiment, learning engine 211 may be used to answer these questions by deciphering or interpreting the data using common behavioral knowledge and rule sets to determine, for example, what else can be known or understood or gathered about this particular location, such as conference room A. For example, learning engine 211 may consider various scenarios as to the identified location based on the available data, such as behavioral data, to determine whether the location is, for example, a common living area, a kitchen, a bathroom, a collaboration room, a conference or meeting room, etc. For example, a user is expect to eat or drink, etc., in a kitchen, sit or lecture in a conference room, wash hands or perform certain other movements in the bathroom, sit and relax or wait in a common living area, and/or the like.

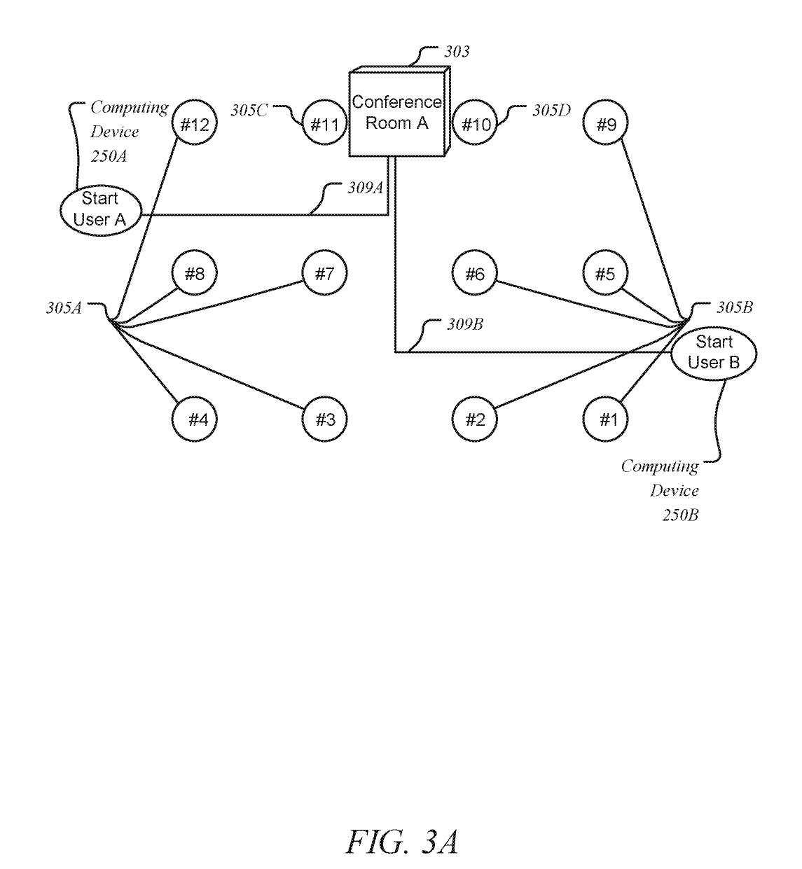

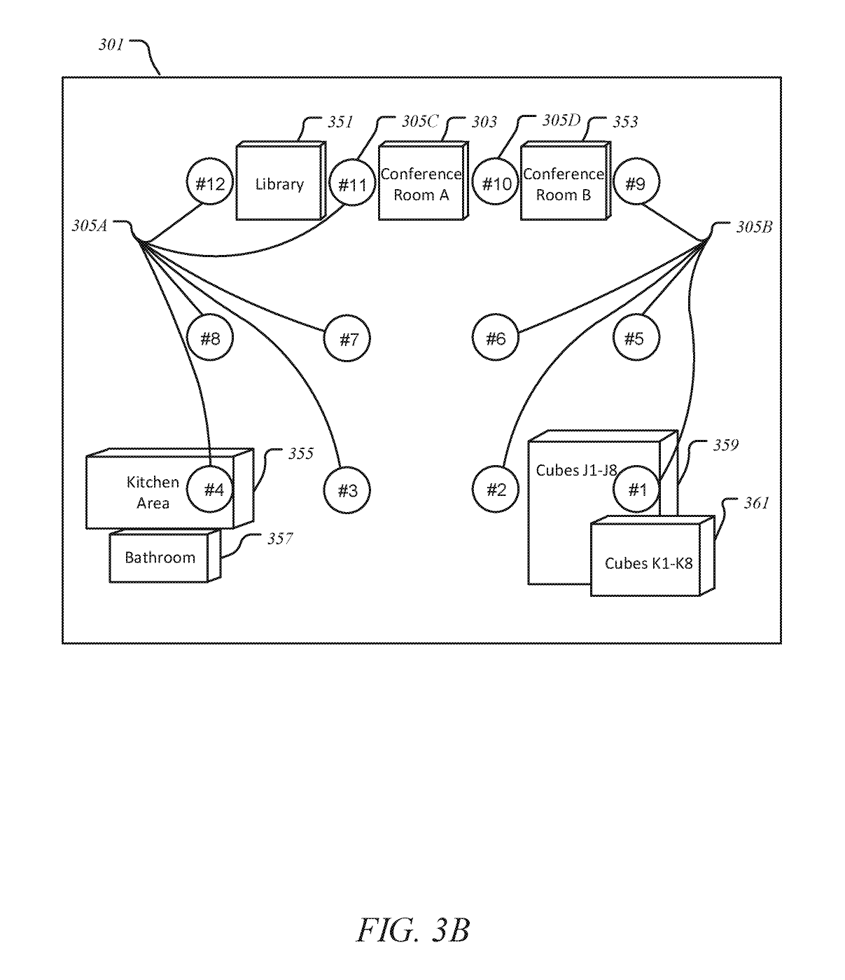

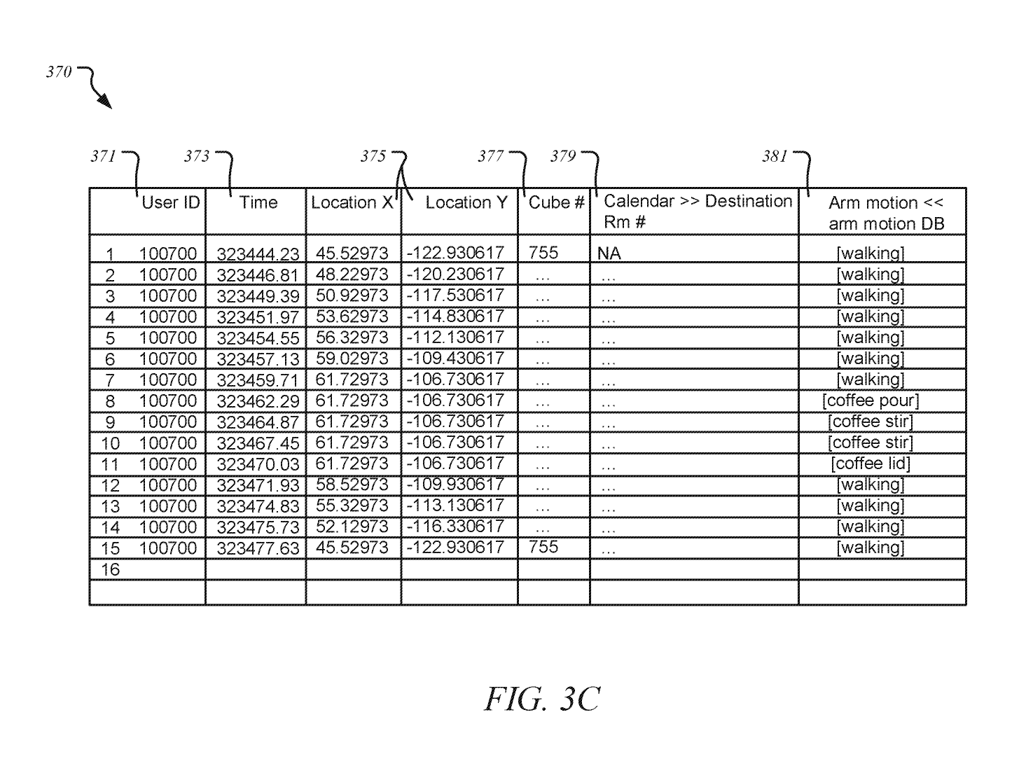

With input from extraneous sources, such as a user's email application or calendar application, etc., any number and type of enterprise applications with data about the users and any rule sets, can be used by learning engine 211 to determine additional information about any specific location in a facility. For example, as illustrated with reference to FIG. 3A, if calendar applications associated with two users, such as users A and B, specifies a particular meeting room, such conference room A, and meeting time, such as 2 PM, then both their computing devices 250A and 250B may be tracked and if arrived at conference room A at or around 2 PM, then this location may be confirmed as conference room A by learning engine 211. It is contemplated that there may be times where user A may take a detour or not attend the meeting or arrive late or early and therefore, in this case, several data points along the path, such as path 309A of FIG. 3A, may be collected by collection logic 205 and analyzed by data analytic engine 207, while learning engine 211 may then be triggered to learn and verify those data points to verify or prove one or more locations along the path of computing device 250A associated with user A, such as a location where user A spends most time is likely to be cubicle 101 of user A.

In one embodiment, various behavioral data and rule sets may be stored at one or more database(s) 225, where any contents of the behavioral data and the rules from the rules sets may be distinctively different for each organization and/or user choosing to adopt this novel technique or choosing to participate. For example, as illustrated with respect to FIG. 3B, one or more rules may be set for locating a cafeteria, such as by monitoring the location (of cafeteria) for each person or client endpoint installed and then aggregating the data of each person's location at about lunchtime, such as at noon or between 11 AM and 1 PM. For example, learning engine 211 may conclude or determine the cafeteria to be an area that has the largest number of persons or client endpoints at around lunchtime, such as tracking any number of people in the building heading towards the location around lunchtime and staying at the location for nearly an hour or so may be sufficient for learning engine 211 to conclude that the location is a cafeteria. Similarly, other rules from the rules sets may be used to determine other types of rooms within the facility, such as common rooms, bathrooms, kitchens, unmarked meeting rooms, etc.

Further, in one embodiment, any data gathered or collected through detection/monitoring logic 203 and/or data collection logic 205, as further facilitated by data access logic 253 and/or data broadcast logic 255, may be analyzed by data analytic engine 207 and filtered by privacy engine 209 and additionally interpreted by learning engine 211 may offer information relating to various parts of a building or a campus, etc., such as a unique view of different rooms, their names, and how the rooms may be used by people at the facility, and/or the like. In one embodiment, learning engine 211 may be used to enhance this information several fold, making this novel technique far more accurate by using, for example, common error filtering techniques, change learning by being able to change locations of areas if the building has been modified, common pathways determined by common traffic areas and shortest path models, and/or the like. For example, in some embodiments, learning engine 211 may be used to develop signatures that can then be subsequently shared through, for example, a web service, where others may then use those signatures to reinforce or expedite identifications of unique rooms or spaces.

It is contemplated and to be noted that throughout this document, terms like “building”, “campus”, “room”, “space”, “facility”, and/or the like, are used as examples for brevity and clarify, but that embodiments are not limited as such. For example, embodiments are not limited to merely business or company buildings and that they may be used with and applied to any number and type of other facilities, such as shopping malls, college campuses, government facilities, airports, prisons, etc.

Once the data has been analyzed, filtered, and interpreted, in one embodiment, map building logic 213 may be triggered to plot the various locations, such as rooms, empty spaces, etc., of a facility, such as a building, on to a map such that each location may be identified and/or described using its name (e.g., primary Ladies Bathroom, Conference room X, etc.), location (e.g., fourth floor-West wing, etc.), timing (available today at 9 AM-noon and 1 PM-3 PM, etc.), other relevant details and/or recommendations (e.g., secondary Ladies Bathroom at fourth floor-East wing, Conference room X under construction or renovation, try Conference room Z next door, etc.), and/or the like.

In one embodiment, this plotting of a map, as facilitated by map building logic 213, may be performed automatically and dynamically based on the changing local environment as detected by data access logic 253 and broadcasted or communicated by data broadcast logic 255 to data collection logic 205 over one or more communication medium(s) 230, such as a cloud network. For example, changes in the local environment may include one or more of construction, renovation, moves, problems, emergencies, etc., such as constructing a new meeting room, renovating a break room, moving offices, out-of-order bathroom, flooding or fire, etc. In one embodiment, these changes may be reported by users, such as user A of computing device 250A, or automatically detected by data access logic 253 by accessing one or more applications, such as calendars, emails, electronic notices or announcements, etc., and/or detecting data through one or more data points or sensors strategically placed throughout the facility.

For example, renovation of a break room may be known from postings on electronic calendars, announcements made through emails, etc., of one or more users associated with a facility, where this information may be accessed from their corresponding computing devices, such as computing device 250A, by data access logic 253. This information may then be communicated on to data broadcast logic 255, which broadcasts or communicates this information over to data collection logic 205 for further analysis and processing.

In one embodiment, recommendation engine 215 may be triggered and provided through navigation/communication logic 257 to offer instant directions, recommendations, etc., to end-users through their respective computing devices 250A-N. For example, recommendation engine 215 may be capable of accessing any number and type of maps created by map building logic 213 and stored at one or more database(s) 225 to serve the users with any amount and type of information about various locations, spaces, landmarks, etc., within a facility as requested by the user.

For example, if user A of computing device 250A wishes to know the nearest conference room in a building and directions to get there, recommendation engine 215 may detect the user's current location, access the most recent map of the building, narrow it down to within a proximate area of the user, and recommend to user A not only the nearest conference room, but also list turn-by-turn directions to the conference room (e.g., shortest distance, fastest distance, etc., as set forth in user profile). These recommendations by recommendation engine 215 may be provided to user A through navigation/communication logic 257 and displayed through user interface 261, as facilitated by interfacing logic 259, of computing device 250A.

Capturing/sensing components 231 and/or I/O component(s) 263 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 and/or I/O component(s) 263 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 and/or I/O component(s) 263 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 and/or I/O component(s) 263 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 and/or I/O component(s) 263 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or Trusted Execution Environment (TEE) logic. TEE logic may be employed separately or be part of resource requestor and/or an I/O subsystem, etc. Capturing/sensing component(s) 231 and/or I/O component(s) 263 may further include voice recognition devices, photo recognition devices, facial and other body recognition components, voice-to-text conversion components, etc.

Similarly, output component(s) 233 and/or I/O component(s) 263 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 and/or I/O component(s) 263 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios, architectural placements, or component setups; however, for the sake of brevity and clarity, illustrations and descriptions with respect to FIGS. 3A-3C are offered and discussed throughout this document for exemplary purposes but that embodiments are not limited as such. Further, throughout this document, “user” may refer to someone having access to one or more computing devices, such as computing devices 250A-N, 100, and may be referenced interchangeably with “person”, “individual”, “human”, “him”, “her”, “child”, “adult”, “viewer”, “player”, “gamer”, “developer”, programmer”, and/or the like.

Compatibility/resolution logic 219 may be used to facilitate dynamic communication and compatibility between various components, networks, computing devices, etc., such as computing devices 100, 250A-N, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “crowd-sourced”, “data collection”, “data analytic”, “map”, “indoor mapping”, “map building”, “learning engine”, “building”, “facility”, “room”, “space”, “directions”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from mapping mechanism 110 and/or participation application 251 to facilitate various embodiments including adding, removing, and/or enhancing certain features. For brevity, clarity, and ease of understanding of mapping mechanism 110 and/or participation application 251, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a use-case scenario 300 according to one embodiment. As an initial matter, for brevity, many of the details discussed with reference to the previous FIGS. 1-2 may not be discussed or repeated hereafter. Further, it is contemplated and to be noted that embodiments are not limited to any particular number or type of architectural placements, component setups, processes, and/or use-case scenarios, etc., such as use-case scenario 300.

In the illustrated embodiment, a facility, such as a building, is shown as having a floor including surface 301 along with any number of spaces, locations, rooms, etc., such as location 303. In one embodiment, as discussed with reference to FIG. 2, any number and type of location points may be strategically determined throughout surface 301, where the location points may then be used to host any number and type of sensors 305A, 305B, 305C, 305D to help track various computing devices, locations, paths, etc., on floor 301. For example, location 303 may be detected and subsequently determined to be a conference room, such as conference room A, situated within close proximity of sensors 305C, 305D.

Moreover, any number and type of sensors 305A-D placed at any number of location points may be used to track one or more users, such as users A and B, by tracking their corresponding computing devices 250A, 250B. Further, computing devices 250A and 250B may be monitored by any number and type of sensors 305A-D at their corresponding location points to further determine paths or routes 309A, 309B taken by users A and B (and their computing devices 250A and 250B), respectively. For example, computing device 250A associated with user A may be primarily tracked or monitored using sensors 305A, 305C, while computing device 250B associated with user B may be primarily tracked or monitored using sensors 305B, 305D.

As discussed with reference to FIG. 2, in one embodiment, data access logic 253 and/or I/O component(s) 263 of computing device 250A may be used to work with relevant sensors 305A-D at various location points throughout floor 301 to collect and accessed relevant data relating to floor 301, location 303, computing devices 250A, 250B, etc., and then trigger data broadcast logic 255 to broadcast or communicate this data to data collection logic 205, where this received data may then be processed, such as analyzed, filtered, interpreted, etc., using any number and type of components of mapping mechanism 110. As further described with reference to FIG. 2, once mapping is prepared using map building logic 213 and offered through recommendation engine 215, any relevant mapping information, such as map of floor 301, location 303 of conference room A, preferred or taken routes 309A, 309B, etc., may be provided to any number of end-users through user interfaces of their computing devices, such as (but not limited to) to user A through user interface 261 of computing device 250A.

FIG. 3B illustrates a use-case scenario 350 according to one embodiment. As an initial matter, for brevity, many of the details discussed with reference to the previous FIGS. 1-3A may not be discussed or repeated hereafter. Further, it is contemplated and to be noted that embodiments are not limited to any particular number or type of architectural placements, component setups, processes, and/or use-case scenarios, etc., such as use-case scenario 350.

The illustrated embodiment illustrates floor 301 having any number and type of sensors 305A, 305B, 305C, 305D strategically placed at any number and type of locations throughout floor 301, where the map of floor 301 further illustrates accurate locations 303, 351, 353, 355, 357, 359, and 361 of conference room A, library, conference room B, kitchen, bathroom, cubes J1-J8, and cubes k1-K8, respectively.

FIG. 3C illustrates a table 370 according to one embodiment. As an initial matter, for brevity, many of the details discussed with reference to the previous FIGS. 1-3B may not be discussed or repeated hereafter. Further, it is contemplated and to be noted that embodiments are not limited to any particular number or type of architectural placements, component setups, processes, tables, and/or use-case scenarios, etc., such as table 370.

In the illustrated embodiment, table 370 is shown as including any amount and type of data that may be used performing of tasks relating to map building, recommending directions and/or routes, and displaying maps, routes, etc., as described throughout this document. For example, table 370 is shown as identifying users 371, tracking times 373, location coordinates 375, location names 377, third-party application data 379, arm motion interpretations 381, and/or the like.

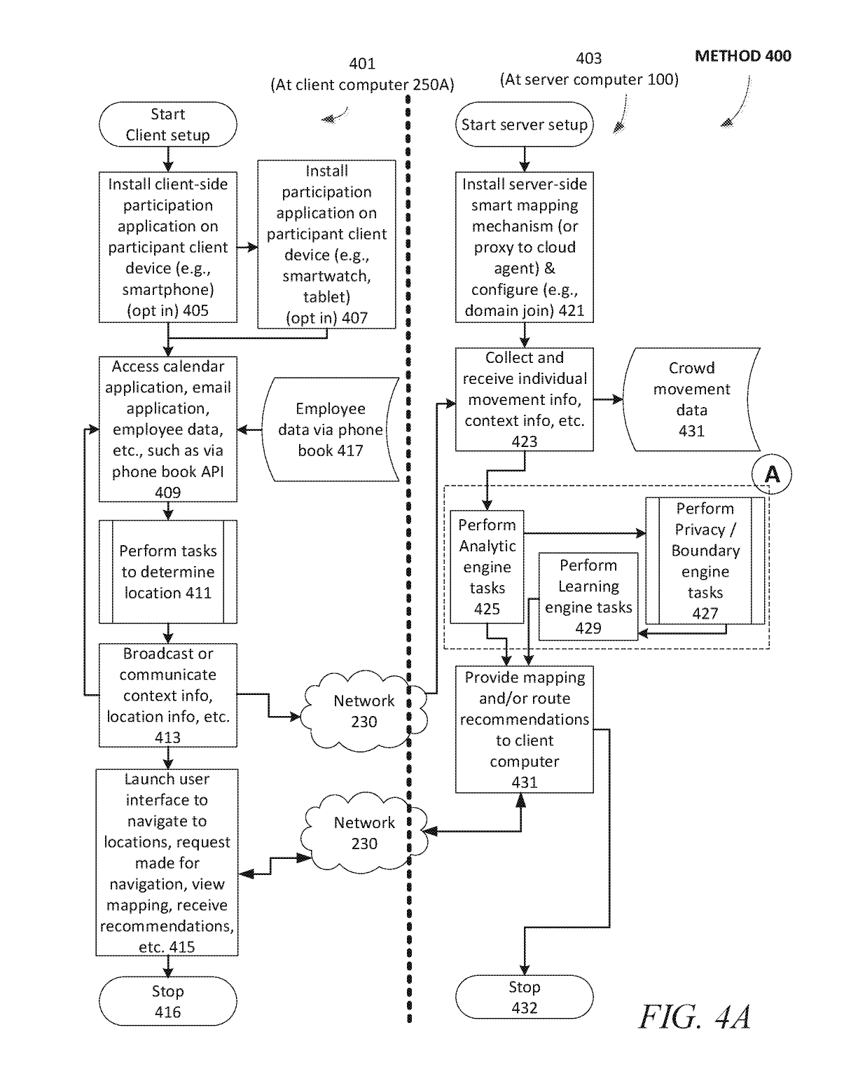

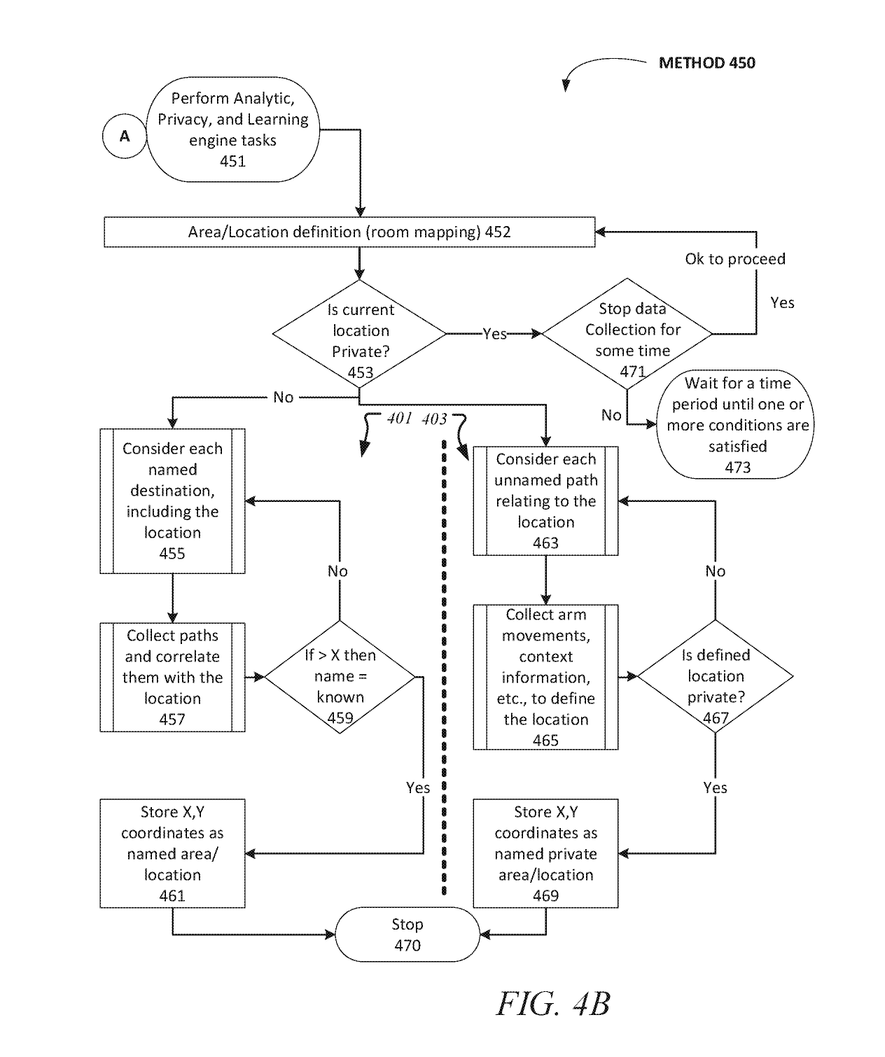

FIG. 4A illustrates a method 400 for facilitating smart crowd-sourced mapping according to one embodiment. Method 400 may be performed by processing logic that may comprise hardware (e.g., circuitry, dedicated logic, programmable logic, etc.), software (such as instructions run on a processing device), or a combination thereof, as facilitated by mapping mechanism 110 and/or participation application 251 FIG. 2. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3C may not be discussed or repeated hereafter.

Method 400 is shown as being performed on client side 401 (such as using participation application 251 at computing device 250A of FIG. 2) and/or server side 403 (such as using mapping mechanism 110 at computing device 100 of FIG. 2). On client side 401, method 400 begins at one or more of blocks 407 and 409 with installing of a client application, such as participation application 251, on a client computer, such as client computing device 250A (e.g., smartphone, smart watch, tablet computer, etc.) of FIG. 2. At block 409, the client application accesses local applications, such as calendar, employee data, phone book, etc., to access and collect relevant data. For example, employee data 417 may be accessed or received through a phone book application having contacts and/or other information relating to the relevant user.

As discussed with reference to FIG. 2, at block 411, one or more locations are determined and any relevant information is accessed and/or collected and, at block 413, this information (e.g., context information, location information, etc.) is then broadcasted or communicated over to a server computer, such as server computing device 100 of FIG. 2, over one or more communication medium(s) 230, such as one or more networks. As further discussed with reference to FIG. 2, this information from block 413 and/or any refined information relating to mapping, locations, paths, etc., received from server side 403 may then be viewed and/or navigated by the user of the client computer using a user interface, such as user interface 261 of FIG. 2, where method 400 on client side 401 ends at block 416.

Referring back to block 413, the relevant information may be broadcasted or communicated over to the server computer on server side 403 where, at block 423, this information is collected (e.g., movement information, context information, etc.) for further processing, such as forming crowd movement data 431 that is then saved at one or more database(s) 225 of FIG. 2. It is contemplated that on server side 403, method 400 may begin with hosting of a server application or mechanism, such as mapping mechanism 110 of FIG. 2.

As further discussed with reference to FIG. 2, the collected information is then analyzed, filtered, interpreted, etc., on server side 403, such as analyzed at block 425 by data analytic engine 207 and filtered for privacy and boundaries at block 427 by privacy engine 209, as further illustrated with reference to FIG. 4B. At block 429, the analyzed and filtered data is further interpreted based on any additional relevant information (e.g., arm movement, user patterns, time of data, logical conclusions, etc.) as facilitated by learning engine 211 of FIG. 2. At block 431, relevant mapping data and/or recommendations, as facilitated by map building logic 213 and recommendation engine 215 of FIG. 2, are then communicated over to client side 401 using one or more communication medium(s) 230, such as one or more networks, and offered to the user at block 415 using a user interface of the client computer, such as user interface 261 of computing device 250A of FIG. 2, where method 400 on server side 403 ends at block 432.

FIG. 4B illustrates a method 450 for facilitating smart crowd-sourced mapping according to one embodiment. Method 450 may be performed by processing logic that may comprise hardware (e.g., circuitry, dedicated logic, programmable logic, etc.), software (such as instructions run on a processing device), or a combination thereof, as facilitated by mapping mechanism 110 and/or participation application 251 FIG. 2. The processes of method 450 are illustrated in linear sequences for brevity and clarity in presentation; however, it is contemplated that any number of them can be performed in parallel, asynchronously, or in different orders. For brevity, many of the details discussed with reference to the previous FIGS. 1-4A may not be discussed or repeated hereafter.

Method 450 begins at block 451 and proceeds at block 452 with evaluation of area definition (e.g., room mapping). At block 453, in one embodiment, a determination is made as to whether this current location is regarded as a private location (e.g., bathroom, room with sensitive or private information or research, etc.). If yes, at block 471, another determination is made as to whether any further data collection regarding the private location be terminated. If yes, method 450 loops back to block 452 with area definition. If not, the method 450 continues at block 473 with waiting on data collection for a period of time until a condition is on (such as for as long as the user is inside or using the bathroom, etc.) and then start collecting any additional data relating to the private location.

Referring back to block 453, if the location is not regarded as private (e.g., conference room, break room, etc.), method 450 continues on client side 401 at block 455 with naming of the location and then, at block 457, collecting data identifying paths and correlating the paths with the location. At block 459, a determination is made as to whether the location name is known. If not, method 450 continues with the naming process at block 455. If yes, method 450 continues with storing the coordinates (such as X, Y) of the location and ends at block 470.

Referring back to block 453, if the location is not regarded as private (e.g., conference room, break room, etc.), method 450 continues on server side 403 at block 463 with collecting data relating to each unnamed path relating to the location. At block 465, any relevant context data, such as arm movement, context information, etc., is collected, interpreted, and defined, as facilitated by learning engine 211 of FIG. 2. At block 467, based on the definition of the location as obtained from the relevant context data, another determination is made as to whether the location is defined as private. If not, method 450 continues with block 463. If yes, method 450 continues with storing of the coordinates, such as X and Y, of the location as named private area at block 469. Method 450 ends at block 470.

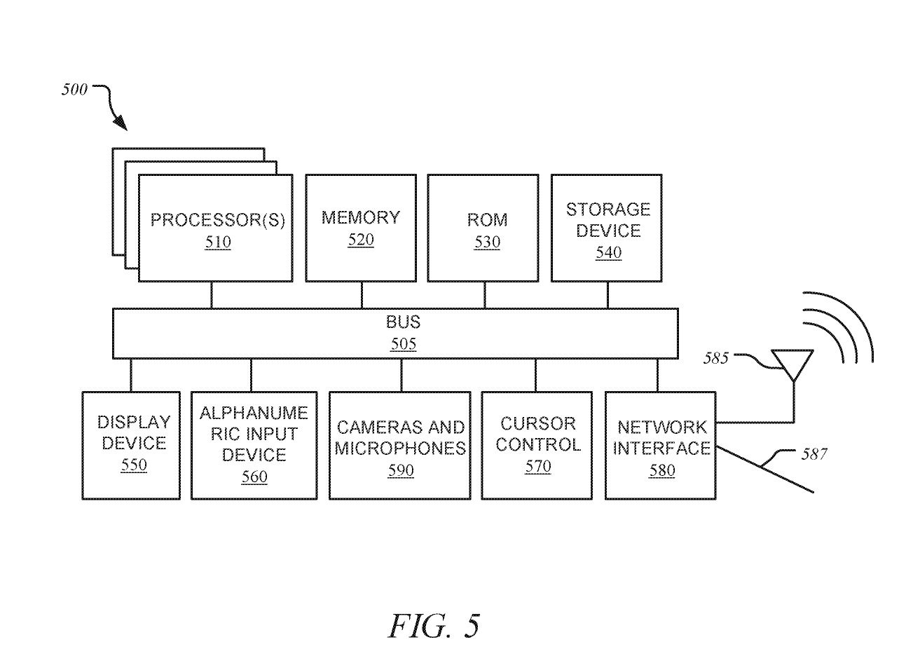

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

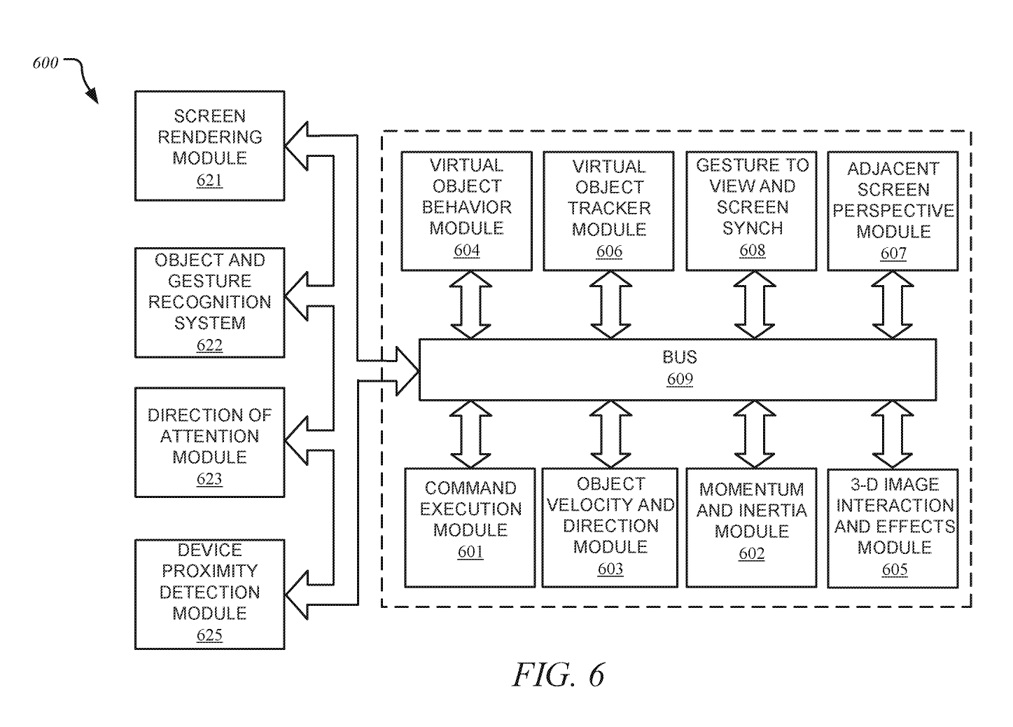

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 6that includes an apparatus to facilitate smart crowd-sourced automatic indoor discovery and mapping, the apparatus comprising: data collection logic to collect data relating to a facility, wherein the data is based on one or more of movement data, contextual data, and observation data relating to at least one of an indoor space and one or more users of the indoor space; learning engine to generate one or more dynamic profiles of the indoor space and the occupants; and map building logic to build a map of the indoor space based on the one or more dynamic profiles.

Example 2 includes the subject matter of Example 1, further comprising location/route recommendation logic to facilitate communication of at least one of the map and one or more recommendations based on the map to one or more computing devices over one or more communication mediums, wherein the one or more computing devices are capable of being accessed by the one or more users.

Example 3 includes the subject matter of Example 2, further comprising: reception/verification logic to receive one or more participation requests from one or more computing devices, wherein the reception/verification logic is further to verify at least one of the one or more computing devices and the one or more users; and detection/monitoring logic to detect or monitor the one or more computing devices over the one or more communication mediums including one or more networks, wherein the one or more networks include a cloud network or the Internet.

Example 4 includes the subject matter of Example 1, wherein the data collection logic is further to facilitate communication between the one or more computing devices and one or more sensors installed at the indoor space of the facility, wherein the data collection logic is further to collect the data using at least one of the one or more computing devices or the one or more sensors.

Example 5 includes the subject matter of Example 1, further comprising data analytic engine to generate a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

Example 6 includes the subject matter of Example 1, further comprising privacy/boundary engine to generate a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

Example 7 includes the subject matter of Example 1, further comprising learning engine to generate a third set of mapping results by evaluating contents of the second set of mapping results, wherein evaluating is based on interpretation of one or more of the movement data, the contextual data, and the observation data to confirm, deny, or modify the description of the one or more locations or the one or more routes.

Example 8 includes the subject matter of Example 1, further comprising: map building logic to build a map based on the third set of mapping results, wherein the map to reflect the indoor space of the facility; and location/route recommendation engine to offer a recommendation relating to a location of the one or more locations or a route of the one or more routes, wherein the recommendation is communicated on to one of the one or more computing devices in response to a request for the location or the route.

Example 9 includes the subject matter of Example 1, further comprising: communication/interfacing logic to facilitate communication with the one or more computing devices or the one or more sensors, wherein the communication/interfacing logic is further to establish interfacing at the one or more computing devices; and compatibility/resolution logic to ensure compatibility with the one or more computing devices or the one or more sensors, and offer one or more resolutions to one or more of communication issues, compatibility issues, and interfacing issues.

Some embodiments pertain to Example 10 that includes a method for facilitating smart crowd-sourced automatic indoor discovery and mapping, the method comprising: collecting data relating to a facility, wherein the data is based on one or more of movement data, contextual data, and observation data relating to at least one of an indoor space and one or more users of the indoor space; generating one or more dynamic profiles of the indoor space and the occupants; and building a map of the indoor space based on the one or more dynamic profiles.

Example 11 includes the subject matter of Example 10, further comprising facilitating communication of at least one of the map and one or more recommendations based on the map to one or more computing devices over one or more communication mediums, wherein the one or more computing devices are capable of being accessed by the one or more users.

Example 12 includes the subject matter of Example 11, further comprising: receiving one or more participation requests from one or more computing devices; verifying at least one of the one or more computing devices and the one or more users; and detecting or monitoring the one or more computing devices over the one or more communication mediums including one or more networks, wherein the one or more networks include a cloud network or the Internet.

Example 13 includes the subject matter of Example 10, further comprising: facilitating communication between the one or more computing devices and one or more sensors installed at the indoor space of the facility; and collecting the data using at least one of the one or more computing devices or the one or more sensors.

Example 14 includes the subject matter of Example 10, further comprising generating a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

Example 15 includes the subject matter of Example 10, further comprising generating a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

Example 16 includes the subject matter of Example 10, further comprising generating a third set of mapping results by evaluating contents of the second set of mapping results, wherein evaluating is based on interpretation of one or more of the movement data, the contextual data, and the observation data to confirm, deny, or modify the description of the one or more locations or the one or more routes.

Example 17 includes the subject matter of Example 10, further comprising: building a map based on the third set of mapping results, wherein the map to reflect the indoor space of the facility; and offering a recommendation relating to a location of the one or more locations or a route of the one or more routes, wherein the recommendation is communicated on to one of the one or more computing devices in response to a request for the location or the route.

Example 18 includes the subject matter of Example 10, further comprising: facilitating communication with the one or more computing devices or the one or more sensors, wherein facilitating communication includes establishing interfacing at the one or more computing devices; and ensuring compatibility with the one or more computing devices or the one or more sensors, and offer one or more resolutions to one or more of communication issues, compatibility issues, and interfacing issues.

Some embodiments pertain to Example 19 includes a system comprising a storage device having instructions, and a processor to execute the instructions to facilitate a mechanism to: collect data relating to a facility, wherein the data is based on one or more of movement data, contextual data, and observation data relating to at least one of an indoor space and one or more users of the indoor space; generate one or more dynamic profiles of the indoor space and the occupants; and build a map of the indoor space based on the one or more dynamic profiles.

Example 20 includes the subject matter of Example 19, wherein the mechanism to facilitate communication of at least one of the map and one or more recommendations based on the map to one or more computing devices over one or more communication mediums, wherein the one or more computing devices are capable of being accessed by the one or more users.

Example 21 includes the subject matter of Example 20, wherein the mechanism to: receive one or more participation requests from one or more computing devices; verify at least one of the one or more computing devices and the one or more users; and detect or monitor the one or more computing devices over the one or more communication mediums including one or more networks, wherein the one or more networks include a cloud network or the Internet.

Example 22 includes the subject matter of Example 19, wherein the mechanism to: facilitate communication between the one or more computing devices and one or more sensors installed at the indoor space of the facility; and collect the data using at least one of the one or more computing devices or the one or more sensors.

Example 23 includes the subject matter of Example 19, wherein the mechanism to generate a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

Example 24 includes the subject matter of Example 19, wherein the mechanism to generate a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

Example 25 includes the subject matter of Example 19, wherein the mechanism to generate a third set of mapping results by evaluating contents of the second set of mapping results, wherein evaluating is based on interpretation of one or more of the movement data, the contextual data, and the observation data to confirm, deny, or modify the description of the one or more locations or the one or more routes.

Example 26 includes the subject matter of Example 19, wherein the mechanism to: build a map based on the third set of mapping results, wherein the map to reflect the indoor space of the facility; and offer a recommendation relating to a location of the one or more locations or a route of the one or more routes, wherein the recommendation is communicated on to one of the one or more computing devices in response to a request for the location or the route.

Example 27 includes the subject matter of Example 19, wherein the mechanism to: facilitate communication with the one or more computing devices or the one or more sensors, wherein facilitating communication includes establishing interfacing at the one or more computing devices; and ensure compatibility with the one or more computing devices or the one or more sensors, and offer one or more resolutions to one or more of communication issues, compatibility issues, and interfacing issues.

Some embodiments pertain to Example 28 includes an apparatus comprising: means for collecting data relating to a facility, wherein the data is based on one or more of movement data, contextual data, and observation data relating to at least one of an indoor space and one or more users of the indoor space; means for generating one or more dynamic profiles of the indoor space and the occupants; and means for building a map of the indoor space based on the one or more dynamic profiles.

Example 29 includes the subject matter of Example 28, further comprising means for facilitating communication of at least one of the map and one or more recommendations based on the map to one or more computing devices over one or more communication mediums, wherein the one or more computing devices are capable of being accessed by the one or more users.

Example 30 includes the subject matter of Example 29, further comprising: means for receiving one or more participation requests from one or more computing devices; means for verifying at least one of the one or more computing devices and the one or more users; and means for detecting or monitoring the one or more computing devices over the one or more communication mediums including one or more networks, wherein the one or more networks include a cloud network or the Internet.

Example 31 includes the subject matter of Example 28, further comprising: means for facilitating communication between the one or more computing devices and one or more sensors installed at the indoor space of the facility; and means for collecting the data using at least one of the one or more computing devices or the one or more sensors.

Example 32 includes the subject matter of Example 28, further comprising means for generating a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

Example 33 includes the subject matter of Example 28, further comprising means for generating a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

Example 34 includes the subject matter of Example 28, further comprising means for generating a third set of mapping results by evaluating contents of the second set of mapping results, wherein evaluating is based on interpretation of one or more of the movement data, the contextual data, and the observation data to confirm, deny, or modify the description of the one or more locations or the one or more routes.

Example 35 includes the subject matter of Example 28, further comprising: means for building a map based on the third set of mapping results, wherein the map to reflect the indoor space of the facility; and means for offering a recommendation relating to a location of the one or more locations or a route of the one or more routes, wherein the recommendation is communicated on to one of the one or more computing devices in response to a request for the location or the route.

Example 36 includes the subject matter of Example 28, further comprising: means for facilitating communication with the one or more computing devices or the one or more sensors, wherein facilitating communication includes establishing interfacing at the one or more computing devices; and means for ensuring compatibility with the one or more computing devices or the one or more sensors, and offer one or more resolutions to one or more of communication issues, compatibility issues, and interfacing issues.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
data collection logic to collect data relating to a facility, wherein the data is based on one or more of movement data, contextual data, and observation data relating to at least one of an indoor space and one or more users of the indoor space;
learning engine to generate one or more dynamic profiles of the indoor space and the occupants; and
map building logic to build a map of the indoor space based on the one or more dynamic profiles.

2. The apparatus of claim 1, further comprising location/route recommendation logic to facilitate communication of at least one of the map and one or more recommendations based on the map to one or more computing devices over one or more communication mediums, wherein the one or more computing devices are capable of being accessed by the one or more users.

3. The apparatus of claim 2, further comprising:
reception/verification logic to receive one or more participation requests from one or more computing devices, wherein the reception/verification logic is further to verify at least one of the one or more computing devices and the one or more users; and
detection/monitoring logic to detect or monitor the one or more computing devices over the one or more communication mediums including one or more networks, wherein the one or more networks include a cloud network or the Internet.

4. The apparatus of claim 1, wherein the data collection logic is further to facilitate communication between the one or more computing devices and one or more sensors installed at the indoor space of the facility, wherein the data collection logic is further to collect the data using at least one of the one or more computing devices or the one or more sensors.

5. The apparatus of claim 1, further comprising data analytic engine to generate a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

6. The apparatus of claim 1, further comprising privacy/boundary engine to generate a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

7. The apparatus of claim 1, further comprising learning engine to generate a third set of mapping results by evaluating contents of the second set of mapping results, wherein evaluating is based on interpretation of one or more of the movement data, the contextual data, and the observation data to confirm, deny, or modify the description of the one or more locations or the one or more routes.

8. The apparatus of claim 1, further comprising:
map building logic to build a map based on the third set of mapping results, wherein the map to reflect the indoor space of the facility; and
location/route recommendation engine to offer a recommendation relating to a location of the one or more locations or a route of the one or more routes, wherein the recommendation is communicated on to one of the one or more computing devices in response to a request for the location or the route.

9. The apparatus of claim 1, further comprising:
communication/interfacing logic to facilitate communication with the one or more computing devices or the one or more sensors, wherein the communication/interfacing logic is further to establish interfacing at the one or more computing devices; and
compatibility/resolution logic to ensure compatibility with the one or more computing devices or the one or more sensors, and offer one or more resolutions to one or more of communication issues, compatibility issues, and interfacing issues.

10. A method comprising:
collecting data relating to a facility, wherein the data is based on one or more of movement data, contextual data, and observation data relating to at least one of an indoor space and one or more users of the indoor space;
generating one or more dynamic profiles of the indoor space and the occupants; and
building a map of the indoor space based on the one or more dynamic profiles.

11. The method of claim 10, further comprising facilitating communication of at least one of the map and one or more recommendations based on the map to one or more computing devices over one or more communication mediums, wherein the one or more computing devices are capable of being accessed by the one or more users.

12. The method of claim 11, further comprising:
receiving one or more participation requests from one or more computing devices;
verifying at least one of the one or more computing devices and the one or more users; and
detecting or monitoring the one or more computing devices over the one or more communication mediums including one or more networks, wherein the one or more networks include a cloud network or the Internet.

13. The method of claim 10, further comprising:
facilitating communication between the one or more computing devices and one or more sensors installed at the indoor space of the facility; and
collecting the data using at least one of the one or more computing devices or the one or more sensors.

14. The method of claim 10, further comprising generating a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes.

15. The method of claim 10, further comprising generating a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations.

16. The method of claim 10, further comprising generating a third set of mapping results by evaluating contents of the second set of mapping results, wherein evaluating is based on interpretation of one or more of the movement data, the contextual data, and the observation data to confirm, deny, or modify the description of the one or more locations or the one or more routes.

17. The method of claim 10, further comprising:
building a map based on the third set of mapping results, wherein the map to reflect the indoor space of the facility; and
offering a recommendation relating to a location of the one or more locations or a route of the one or more routes, wherein the recommendation is communicated on to one of the one or more computing devices in response to a request for the location or the route.

18. The method of claim 10, further comprising:
facilitating communication with the one or more computing devices or the one or more sensors, wherein facilitating communication includes establishing interfacing at the one or more computing devices; and
ensuring compatibility with the one or more computing devices or the one or more sensors, and offer one or more resolutions to one or more of communication issues, compatibility issues, and interfacing issues.

19. At least one machine-readable medium comprising instructions which, when executed by a computing device, cause the computing device to:
collect data relating to a facility, wherein the data is based on one or more of movement data, contextual data, and observation data relating to at least one of an indoor space and one or more users of the indoor space;
generate one or more dynamic profiles of the indoor space and the occupants; and
build a map of the indoor space based on the one or more dynamic profiles.

20. The machine-readable medium of claim 19, wherein the computing device to facilitate communication of at least one of the map and one or more recommendations based on the map to one or more computing devices over one or more communication mediums, wherein the one or more computing devices are capable of being accessed by the one or more users.

21. The machine-readable medium of claim 20, wherein the computing device to:
receive one or more participation requests from one or more computing devices;
verify at least one of the one or more computing devices and the one or more users; and
detect or monitoring the one or more computing devices over the one or more communication mediums including one or more networks, wherein the one or more networks include a cloud network or the Internet.

22. The machine-readable medium of claim 19, wherein the computing device to:
facilitate communication between the one or more computing devices and one or more sensors installed at the indoor space of the facility; and
collect the data using at least one of the one or more computing devices or the one or more sensors.

23. The machine-readable medium of claim 19, wherein the computing device to:
generate a first set of mapping results by analyzing the data, where analyzing includes one or more of detecting one or more locations within the indoor space, determining one or more names of the one or more locations, and specifying one or more coordinates of the one or more locations, wherein analyzing further includes determining one or more routes taken by the one or more users to or from the one or more locations, wherein the first set of mapping results includes one or more of description of the one or more locations, the one or more names, the one or more coordinates, and the one or more routes;
generate a second set of mapping results by filtering contents of the first set of mapping results, wherein filtering is based on one or more privacy factors defined by at least one of one or more user profiles associated with the one or more users, governmental laws, local rules, company policies, cultural expectations, and other regulations; and
generate a third set of mapping results by evaluating contents of the second set of mapping results, wherein evaluating is based on interpretation of one or more of the movement data, the contextual data, and the observation data to confirm, deny, or modify the description of the one or more locations or the one or more routes.

24. The machine-readable medium of claim 19, wherein the computing device to:
build a map based on the third set of mapping results, wherein the map to reflect the indoor space of the facility; and
offer a recommendation relating to a location of the one or more locations or a route of the one or more routes, wherein the recommendation is communicated on to one of the one or more computing devices in response to a request for the location or the route.

25. The machine-readable medium of claim 19, wherein the computing device to:
facilitate communication with the one or more computing devices or the one or more sensors, wherein facilitating communication includes establishing interfacing at the one or more computing devices; and
ensure compatibility with the one or more computing devices or the one or more sensors, and offer one or more resolutions to one or more of communication issues, compatibility issues, and interfacing issues.
